(19) United States
(12) Patent Application Publication
(10) Pub. No.: US 2004/0024538 A1
(43) Pub. Date: Feb. 5, 2004

(54) Liquid water content measurement apparatus and method using rate of change of ice accretion

(75) Inventors: John A. Severson, Eagan, MN (US); Kenneth J. Schram, Eden Prairie, MN (US)

Correspondence Address: Nickolas E. Westman, Westman, Champlin & Kelly, Suite 1600, 900 Second Avenue South, Minneapolis, MN, 55402-3319, US

(73) Assignee: Rosemount Aerospace Inc., Burnsville, MN

(21) Appl. No.: 10/628,551

(22) Filed: Jul. 28, 2003

Related U.S. Application Data
(63) Continuation-in-part of application No. 10/401,650, filed on Mar. 28, 2003.
Application No. 10/401,650 is a continuation of application No. 09/641,298, filed on Aug. 18, 2000, now Pat. No. 6,560,551.

(51) Int. Cl. G06F 19/00; G01N 31/00

(52) U.S. Cl. 702/24

(57) ABSTRACT

Ice accretion on a probe is detected with various ice detectors to provide a signal indicating the rate of ice accretion. The rate of change of ice accretion is determined and is combined with parameters including air velocity, air pressure and air temperature for providing a signal that indicates liquid water content in the airflow, as well as ice accretion on the ice detector.

This application is a continuation-in-part of my co-pending U.S. patent application Ser. No. 10/401,650, filed Mar. 28, 2003, which in turn is a continuation of U.S. patent application Ser. No. 09/641,298, filed Aug. 18, 2000, now U.S. Pat. No. 6,560,551 and priority on both applications is hereby claimed under 35 U.S.C. § 120.

### BACKGROUND OF THE INVENTION

The present invention relates to an apparatus and method for determining with accuracy the liquid water content of ambient air, particularly in relation to air flows across air vehicles or other structures. The accurate and timely measurement of liquid water content permits prompt signaling for activating deicing systems, and also permits sensing atmospheric conditions for reporting or research purposes.

Unheated bodies exposed to airflow laden with supercooled water droplets will typically accrete ice as the droplets impact the body and freeze. Icing is particularly a problem with air vehicles. Determining when ice is starting to form or predicting when it will form is important in aircraft management of deicing equipment including heaters, which can consume huge amounts of power. When the air temperature is cold enough, 100% of the droplets carried in the airflow will freeze. If the temperature warms or airflow is increased, the energy balance relationship is altered. A critical liquid water content is reached where not all of the impinging supercooled water droplets freeze. This critical liquid water content is defined as the Ludlam Limit. The Ludlam Limit is described in an article by F. H. Ludlam entitled The Heat Economy of a Rimed Cylinder. Quart. J. Roy. Met. Soc., Vol. 77, 1951, pp. 663-666. Additional descriptions of the problem are in articles by B. L. Messinger, entitled Equilibrium Temperature of an Unheated Icing Surface as a Function of Air Speed, Journal of the Aeronautical Sciences, January 1953, and a further article entitled An. Appraisal of The Single Rotating Cylinder Method of Liquid Water Content Measurement, is by J. R. Stallbrass, Report—Low Temperature Laboratory No. LTR-LT-92, National Research Council, Canada, 1978.

It has been shown that if the liquid water content increases above the Ludlam Limit, the accretion characteristics in theory remain unchanged, because excess water simply blows off or runs off, rather than freezing. Thus, present systems for determining liquid water content based on ice accretion suffer degraded accuracy above the Ludlam Limit. The Ludlam Limit for a given temperature and airflow is the liquid water content above which not all of the water freezes on impact with an accreting surface.

Accretion based ice detectors are frequently designed with probes that permit ice build up to a set mass, perhaps taking 30 to 60 seconds depending on conditions, at which time the presence of ice is enunciated or indicated, and a probe heater energized to melt the ice. Such ice detectors are well known in the art, and many depend upon a vibrating sensor or probe, with a frequency sensitive circuit set to determine frequency changes caused by ice accreting on the detector probe.

Liquid water content can be roughly determined by monitoring a signal proportional to the probe icing rate, which again can be determined with existing circuitry, but accuracy degrades rapidly if the liquid water content is above the Ludlam Limit, because a portion of the impinging water never freezes. In such cases the actual liquid water content will be under reported, with the Ludlam Limit liquid water content being the maximum that will be reported. Even though the droplet cloud may contain additional liquid water content, there will be no indication from such an ice detector that there is additional liquid water in the air flow. Thus, the prior art devices will not discern the actual liquid water content when the Ludlam Limit has been exceeded.

### SUMMARY OF THE INVENTION

The present invention relates to determining the liquid water content in an airflow, in particular, air flow past an air data sensing probe on an air vehicle. The amount of the liquid water in the airflow is determined even for liquid water content levels above the Ludlam Limit. The present invention senses ice growth rate on an ice detector. The ice growth rate is predictably variable over an accretion cycle based upon the incremental rate of change of the probe output throughout the sensing cycle. The rate of change of ice accretion evidenced by rate of change of the probe vibration frequency (df/dt) or other disclosed parameter throughout the ice accretion cycle is determined. Further, the rate of change of ice accretion characteristics are demonstrated to be a predictable function of liquid water content, even above the Ludlam Limit, meaning that liquid water content can be determined at the higher liquid water content level.

The rate of change of ice accretion is determined for all or a portion of the ice accretion phase of the probe operating cycle, because it has been determined that this rate of change is a function of liquid water content of the air flow at that time.

In order to measure liquid water content with the present invention, the air speed and the temperature of the ambient air must be known. These basic parameters are readily available from an air data computer, using outside instrumentation, such as a pitot tube or a pitot-static tube, and a temperature sensor, such as a total air temperature sensor. The known liquid water content at a particular known air speed, temperature and rate of change of ice accretion, evidenced by signals from ice detectors are determined and combined in a look up table. The values can be determined by actual icing wind tunnel tests for the respective types of probes, or test results can be used to derive an algorithm that provides liquid water content when the three variables, air flow rate (or air speed), temperature and rate of change of ice accretion on the ice detector is known. A frequency rate of change is described as well as the rate of change of other signals sensitive to ice accretion are disclosed. A signal based on the rate of change of ice accretion (but not merely the amount of ice accretion) is a key to proper results.

The overall ice accretion time has been found to decrease with increasing liquid water content in most cases, but this is not assured. This invention is dependent on ice accretion, and will approach some limit of usefulness when operating conditions are such that little or no ice accretes on the probe. This may occur under conditions of warmer air temperature and high aerodynamic heating, for example.

### BRIEF DESCRIPTION OF THE DRAWINGS

FIG. 1 is a schematic block diagram of the apparatus used for determining liquid water content in response to rate of change of frequency caused by commencement of ice accretion on a vibrating probe and for controlling probe heater deicers;

FIG. 2 is a plot of measured rate of change of frequency during ice accretion at −5° C. temperature, with a constant air speed of 200 knots with airflows having three different, but known levels of liquid water content in the air flow;

FIG. 3 is a plot similar to FIG. 2 with the indications taken at −10° C. and a constant air speed of 200 knots with the same liquid water content in the airflows;

FIG. 4 is a plot of rate of change of frequency during ice accretion of a typical vibrating probe at −5° C. and a speed of 100 knots;

FIG. 5 is a composite plot of points derived as an average of several rate of change of frequency values (df/dt) of a test probe as a function of liquid water content at different air speeds and temperatures.

FIG. 6 is a schematic representation of an ice detector that determines ice accretion on a surface such as an aircraft surface or other surface, utilizing back scattered light techniques to provide an electrical output signal to determine ice accretion and rate of change of ice accretion;

FIG. 7 is a further modified form of ice detection showing the ability to determine ice accretion on an orifice on a surface such as an aircraft surface, using a pressure sensor that delivers a signal proportional to pressure, which can be used for determining the rate of change of ice accretion;

FIG. 8 is a plot showing the signal from the pressure sensor of FIG. 7 as it is affected by ice accretion;

FIG. 9 is a schematic plan view of a typical surface having a microwave wave guide thereon used for determining accreted ice;

FIG. 10 is a sectional view of a device similar to that shown in FIG. 9;

FIG. 11 is a schematic sectional view of a further modified ice detector for determining ice accretion using a self heating resistance thermometer; and

FIG. 12 is a graphical representation of the operation of the ice detector of FIG. 11.

### DETAILED DESCRIPTION OF THE EXEMPLARY EMBODIMENTS

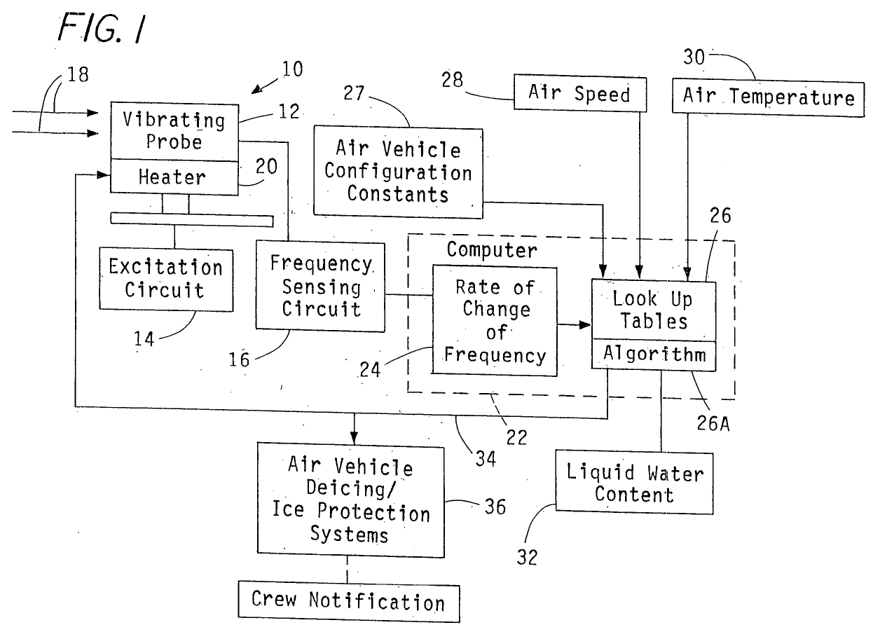

FIG. 1 illustrates a typical set up for utilization of an existing ice detecting probe and the circuitry for determining liquid water content even above the Ludlam Limit. The apparatus 10 includes a vibrating ice collecting or detector probe 12, such as that sold by Rosemount Aerospace Inc., Burnsville, Minn., as its Model 0871 series. An early vibrating, resonant frequency ice detector probe is shown in U.S. Pat. No. 3,341,835 to F. D. Werner et al.

In a first form of the present invention, an excitation circuit 14 is used for providing an excitation signal to vibrate the vibrating probe at a resonant frequency. A known frequency sensing circuit 16 is utilized for determining changes of frequency of the vibrating ice detector probe in a conventional manner. The change in frequency is caused by ice accretion on the surface of the ice detector probe. This design is recognized to be insensitive to probe contaminants such as dirt and insects. The rate of accretion of ice is reflected in the rate of change of frequency. The rate of ice accretion is directly related to the liquid water content of the air. The probe 12 is exposed to airflow as indicated by the arrows 18, and supercooled water droplets will impact and freeze on the probe 12 surface or previously accreted ice at surface temperatures below freezing. The signal 34 indicating ice formation can be used for turning on deicing equipment 36 or other ice protection systems for the air vehicle involved and/or notifying the crew of an icing condition. The signal 34 indicating ice formation can be tailored to the particular air vehicle and its level of tolerance for ice buildup, such that deicing equipment is activated in a timely manner, while nuisance activations are minimized.

The look up tables 26 or algorithm 26A are designed to determine an icing severity level. After a predetermined duration of exposure at a particular icing condition constituting an icing severity level, or an aggregate of conditions resulting in equivalent ice buildup or impact to the aircraft, the signal 34 is supplied. The signal may be supplied continually or on a periodic basis until the icing condition abates. The calculated df/dt value changes and provides the indication of ice formation, and when correlated to airspeed and temperature is used as the measured parameter for turning on deicing heaters and determining liquid water content. The heaters indicated at 20 that are associated with the ice detector probe, for removing the ice that has built up on the probe during the operational cycle, may also be activated with this signal. The advantage is that reset times may be faster than current practice of deicing the probe after a set mass of ice has accreted.

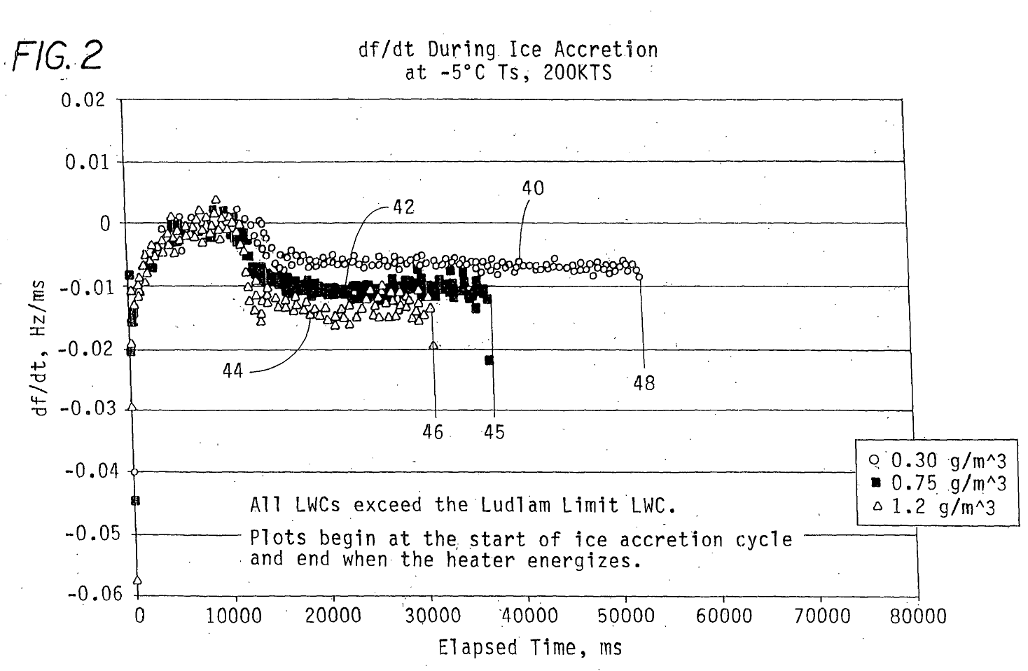

In the present invention, the frequency sensing circuit 16 provides an indication of the change of frequency of the probe 12, and this signal is provided to computer 22 that includes a time input to provide a rate of change of frequency determination section 24. The rate of change of frequency (df/dt) is a function of liquid water content, air temperature and airspeed and is determined in a matter of milliseconds during initial ice accretion, and updated continually until the deicing heaters are turned on. The heaters can be turned on at a selected time after an initial df/dt signal, or when df/dt reaches a selected value. The probe heaters remain on long enough to deice the probe after which the cycle repeats. The correlation of the frequency rate change signal to liquid water content can be provided in a look up table shown at 26, or by entering the parameters into an algorithm in memory section 26A of the computer 22. Based upon temperature and airspeed inputs, and the measured rate of change of frequency over all or a portion of the ice accretion cycle as shown in FIGS. 2, 3 and 4, the liquid water content measurement can be determined.

The look up tables or algorithm reflecting the measured plots include an input of the indicated air speed 28. For example, an input from a pitot tube, or other suitable air speed indicator, that determines the relative velocity of the airflow 18 past the vibrating probe 12 may be used. An additional input parameter is air temperature indicated at 30, which can be obtained from a known total air temperature sensor, or an ambient air temperature sensor, as an input to the look up table 26 or algorithm section 26A.

Air vehicle configuration constants, including for example the aircraft tolerance to ice build up can be an input, as indicated at 27. These factors can insure timely activation, while minimizing nuisance activation, of ice protection equipment, and also can insure a more correct liquid water content indication.

The known relationship of the liquid water content to the rate of change of frequency, air speed and air temperature, and if desired, aircraft configuration constants, then will provide a signal that is a direct, reliable indication of liquid water content as indicated at 32. This liquid water content information can be used for research or analysis of the ambient air. Additionally, the output of the look up table and computer 22 can be utilized for activating the probe heater 20, as shown by a signal along the line 34, and also can then be used for activating and turning on the air vehicle surface deicing heaters indicated at 36 and/or notifying the crew of an icing condition, which comprise one form of ice protection system.

Utilizing a vibrating type ice detector, and using known air temperature and airflow velocity, in one plot a temperature of −5° C., and an air velocity of 200 knots, the results at three different levels of liquid water content are plotted in FIG. 2. It can be seen that at the known liquid water content levels of 0.3, 0.75 and 1.2 grams per cubic meter, indicated by the plots 40, 42 and 44, respectively, the rate of change of resonant vibration frequency of the ice detector probe as ice accretes on the detector probe provides an indication of the liquid water content that can be identified quickly. The elapsed time is very short before distinct patterns emerge. For example, within 10,000 milliseconds a determination of the rate of change in frequency in Hertz per millisecond can be examined and determined from the plotted data points. At 20,000 milliseconds the data for each liquid water content merge and the plots are clearly defined. From commencement of accretion to about 5,000 milliseconds the data points run together and are somewhat scattered. The plots or curves are derived using air samples with a known liquid water content. All of the liquid water content liquid water content samples used in plotting FIG. 2 have a liquid water content that is above the Ludlam Limit at the temperature and airflow rates disclosed.

The heaters for deicing the ice detector probe 12 are turned on at the ends of the plots in FIGS. 2, 3 and 4. For example, the probe heaters are turned on at the time represented by vertical lines 45 and 46 in FIG. 2 for the plots at 0.75 and 1.2 grams per cubic meter, and are turned on at the time shown by vertical line 48 for 0.3 grams per cubic meter. The heater turn on signal is given when the ice has built up on the probe to affect the frequency signal from the probe a desired amount.

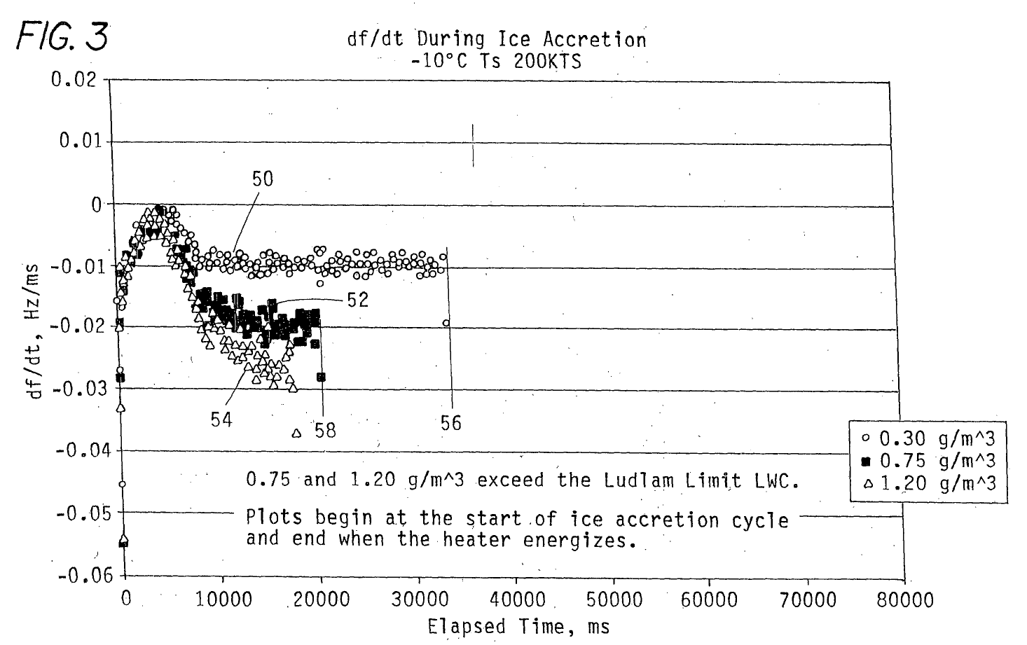

Identifiable results are also achievable with a lower ambient air temperature, −10° C., as illustrated in FIG. 3, and at the same air velocity of 200 knots. The plots for 0.3, 0.75 and 1.25 grams per cubic meter are indicated at 50, 52 and 54, respectively. The measured data points for each liquid water content merge closely together to define distinct identifiable plots of df/dt in less than 10,000 milliseconds to provide an indication of the liquid water content, regardless of whether the content is above the Ludlam Limit. In FIG. 3, (−10° C. and 200 knots) only 0.75 and 1.2 g/m³ plots exceed the Ludlam Limit of liquid water content.

Again, the probe heaters are turned on where the plots end in FIG. 3, generally along a vertical line 58, for the plots where the liquid water content is above the Ludlam Limit, namely plots 52 and 54, and a vertical line 56 for the turning on of the deicing heater on the vibrating type deicer probe when the liquid water content is below the Ludlam Limit, namely 0.30 g/m³.

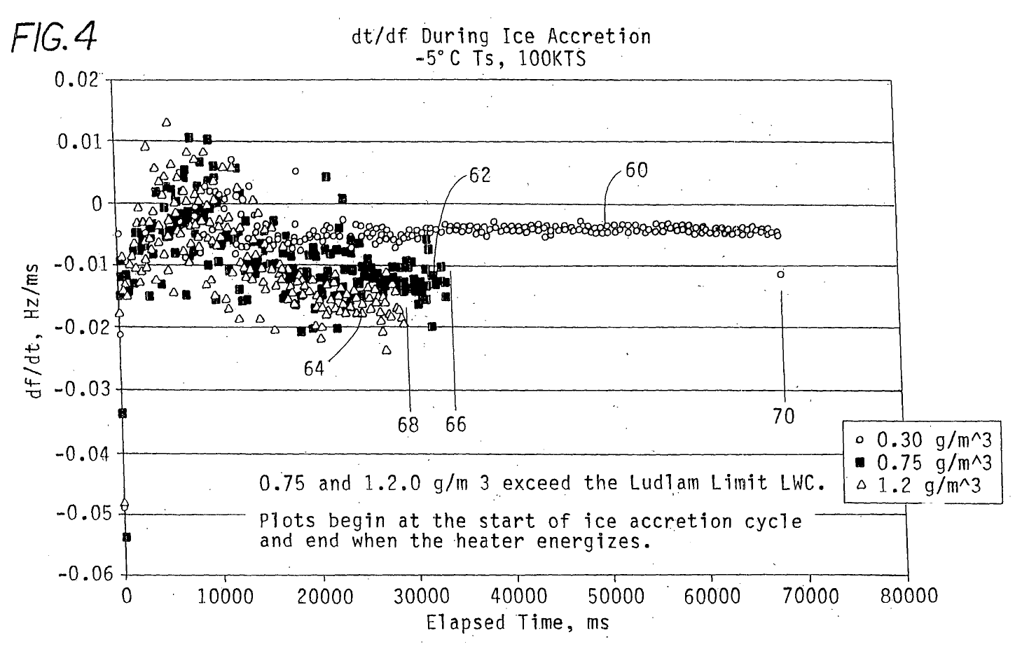

FIG. 4 shows further plots of the rate of change of frequency in hertz per millisecond plotted against time, in milliseconds. In this case, the temperature is −5° C. and airspeed is 100 knots. While somewhat more scattered, the data points can be averaged so that the plots for the liquid water content of 0.30 g/m³, is shown at 60. The 0.30 g/m³ is below the Ludlam Limit while the others are above the limit. The plot for 0.75 g/m³ is indicated at 62, and the plot for an of 1.20 g/m³ is indicated at 64, these plots all show that the rate of change of frequency, df/dt provides sufficient information to indicate the liquid water content within about 15,000 milliseconds with reliability. Again, in this instance, the heaters are turned on at a time indicated by vertical lines 66 and 68 for the plots of 0.75 and 1.20 g/m³, respectively, and the heaters are turned on for the plot for the 0.30 g/m³ at the time line 70.

The rate of change of frequency df/dt, will provide information indicating the rate of ice accretion in each of the plots, even though the liquid water content may be above the Ludlam Limit. This can provide for early information to the crew of an icing condition and/or activation of the deicing heaters on the air vehicle to avoid any substantial build up of ice. Also, the information on liquid water content can be used for research and analysis because the present invention gives a reliable indication of liquid water content at substantially all ranges of liquid water content.

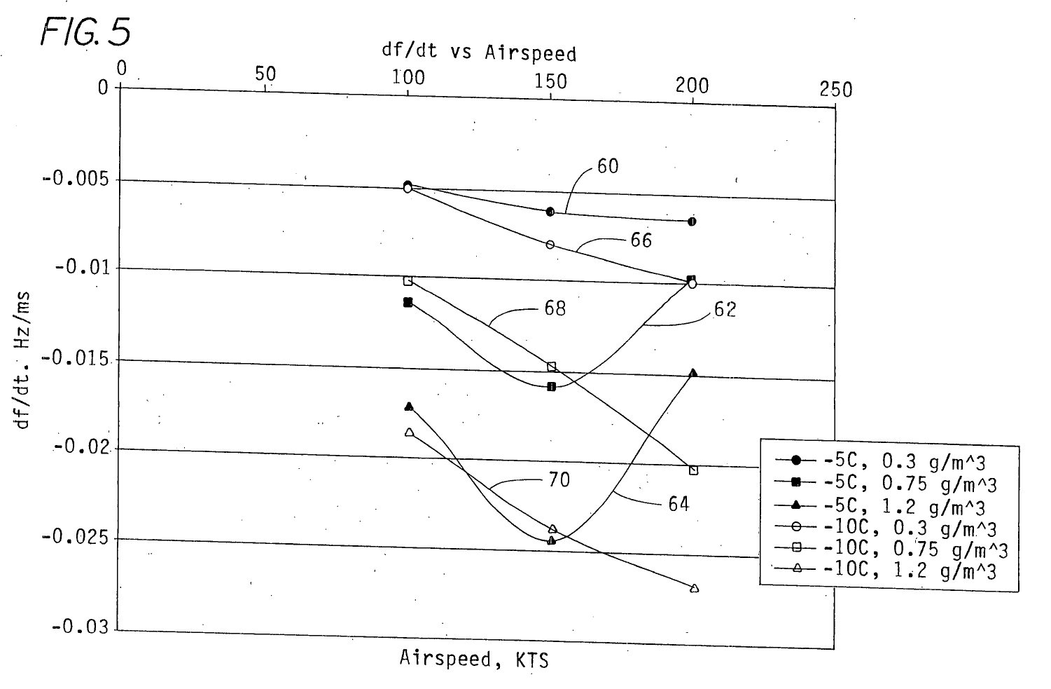

FIG. 5 is a plot of df/dt averaged data points for different airspeeds to show that there are distinct indications of liquid water content at different air speeds, different liquid water content amounts, and different temperatures such that liquid water content can be determined reliably.

The points on the plot are derived from an average of approximately 20 data point readings near the ends of the plots for corresponding liquid water content shown in FIGS. 2, 3 and 4, as well as similar data points taken at different airspeeds and temperatures as listed in FIG. 5. For example, at a temperature of −5° C., three plots are provided for liquid water contents of 0.3, 0.75 and 1.2 g/m³. Each of these conditions of temperature and known liquid water content were used to determine df/dt of a vibrating probe at airflows of 100, 150 and 200 knots.

The plot shown at 60 is with 0.30 g/m³ of liquid water at −5° C., and at 100, 150 and 200 knots. The change in rate of change of frequency (df/dt) does not show wide swings, but shows definitive changes between the air flows to indicate liquid water content at particular air speeds and temperature based upon the rate of change of frequency.

Plot 62 represents data points for df/dt at −5° C. and 0.75 g/m³ liquid water content, and shows greater changes between the listed air speeds.

The plot 64 is for −5° C. with a liquid water content of 1.2 g/m³. Again, the rate of change of frequency provides a distinctive signal at each of the various air speeds to permit direct indication of liquid water content.

At −10° C., the 0.3 g/m³ liquid water content measuring df/dt results in a plot 66; the 0.75 g/m³ liquid water content results in a plot 68, and the 1.2 g/m³ liquid water content provides a plot 70. Again, the individual points shown for the plots 60, 62, 64, 66, 68 and 70 are averages of df/dt of data points taken shortly before the heater is turned on, or near the right hand end of the plots of data points shown in FIGS. 2, 3 and 4.

In aggregate, the plots of FIG. 5 show that definitive points are established at each air speed temperature and df/dt condition, so that upon determining the rate of change of frequency after a selected time from the start of ice accretion, the liquid water content at a particular temperature and a particular air speed can be determined by a lookup table or by an algorithm. The look up table values can be extrapolated for different airspeeds and temperatures, so knowing df/dt the liquid water content can be determined. Also df/dt can give the desired information on when to turn on the heaters.

In FIG. 6, an ice detector indicated generally at 90 is of a modified form, and in this case, it is an optical ice detector. A transparent wall 92 that can be part of a probe, or a portion of a surface which is exposed to ambient air flow, receiver impinging air flow as indicated by the arrow 94. A source of light 96 transmitted through a light wave guide 98 provides light from the interior through the transparent wall 92, to the exterior surface subjected to air flow. A light wave guide 100 is optically coupled to the inner surface of wall 92 adjacent guide 98 and carries or transmits back scattered or reflected light from the wall 92.

When there is a start of ice build up, as indicated generally at 102 on the exterior surface of wall 92, the light from source 96 will be back scattered as indicated by the arrows 104, and carried by the wave guide 100 to a photo detector receiver 106. This photo detector receiver 106 provides an output signal represented at 108 that is proportional to light intensity, and the change in output signal 108 indicates the amount of ice that is accreting on the surface of the transparent wall 92. Changes in the output signal 108 are similar in provided information to the changes in the frequency signal previously discussed. The output signal at 108 is provided to a sensing system that is indicated at 110. The block 110 represents an instrumentation package that is based upon the previously explained instruments necessary for determining the liquid water content.

The instrumentation package 110 includes the computer 22, the lookup tables or algorithms indicated at 26 and 26A, which in this case would be correlated to tests that would be conducted with the optical ice detector 90, so that the output signal 108 can be correlated to the air vehicle configuration constant 27, the air speed 28, and the air temperature 30. This information is provided to either the lookup tables 26 or the algorithm 26A. The output signal 108 is passed through a computation circuit 24X that determines the rate of change of the output signal (changes occurring during a selected time period), and when combined with the information relating to the air speed, air temperature and air vehicle configuration constant, in the lookup tables or the algorithm, the liquid water content output shown at 32 is provided.

The indication of rate of change of ice accretion is thus achieved with a different type of ice, detector, merely by determining the rate of change of output signal 108 from the sensing device comprising the optical ice detector 90 that is sensitive to ice accretion.

The back scattering light techniques are such that when there is no ice on the outer surface of the wall 92, there is no substantial back scattered light, and as the ice accretes, the amount of back scattered light increases, and the change of this increase of back scattered light across a known time would be used to determine the rate of change of the ice accretion parameter. The transparent surface or wall 92 can also be heated periodically, in a known manner, to clear ice from the surface to start another measurement cycle.

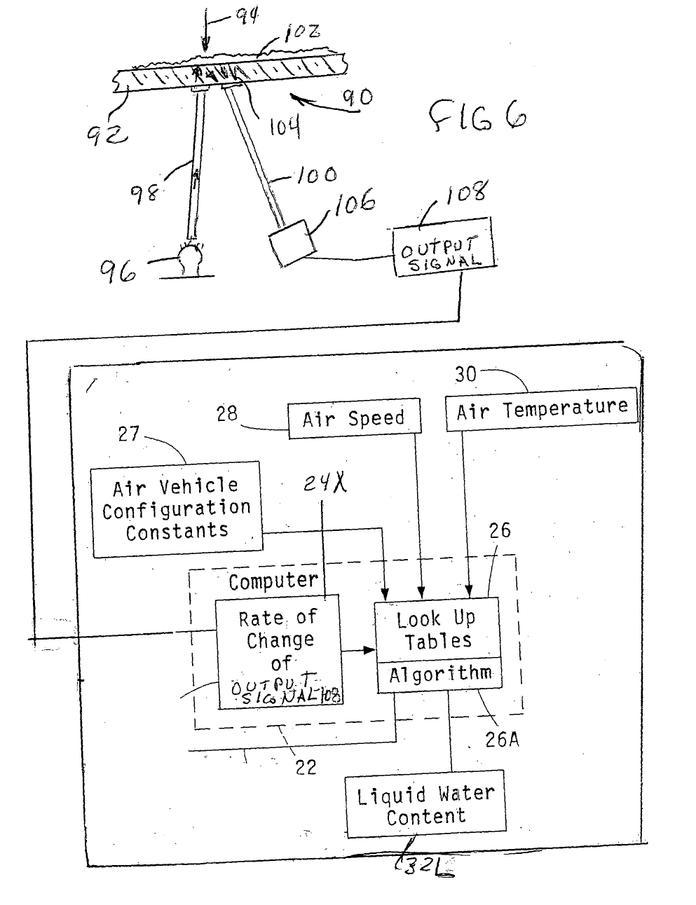

FIG. 7 shows a modified ice detector indicated at 116. A wall 118, which can be on a probe, (a curved wall section) or on the surface of an air vehicle, such as a portion of the leading edge of the wing, is provided with a pressure sensing orifice or port 120, which leads through a pressure line 122 to a suitable pressure sensor 124. As a layer of ice 119 accretes, the ice starts to block orifice or port 120 and the sensed pressure changes.

The pressure sensor 124 can be any selected type that provides an electrical output signal proportional to the pressure, as represented at 126. A capacitive pressure sensor, or a solid state pressure sensor, is suitable. The output signal 126 changes as pressure at the orifice changes, and the output signal 126 is provided to the computation circuitry 110, which includes the computer 22 and the other inputs previously described in connection with the showing in FIG. 6. The rate of change circuitry 127 is used to determine the rate of change of ice accretion from the sensed changes in pressure, and combined with the other parameters such as air temperature, air speed, and air vehicle configuration constants, and compared in a lookup table or an algorithm, again to provide a liquid water content output indicated at 32P.

Lookup tables and algorithms in the computation circuitry 110 can be developed from actual wind tunnel tests to determine the changes in sensed pressure caused by the accretion of ice over the orifice 120. It should be noted that the signal from the pressure sensor gets noisier with time as shown at 130 in FIG. 8, as ice accretes, until the orifice or port 120 is blocked. This change in signal 130 provides an indication that ice is starting to cover the orifice of port 120. When the port 120 is fully covered, the pressure signal is steady, as represented by the line 128.

The rate of change of the noise from the pressure signal indicated by the plot 130 can be determined in the computation circuitry 110. The plot of FIG. 8 also shows that a determination of the time needed from a first indication of ice (the noise increases a set amount) until the port freezes over (line 128) can be used to determine the rate of change of ice accretion.

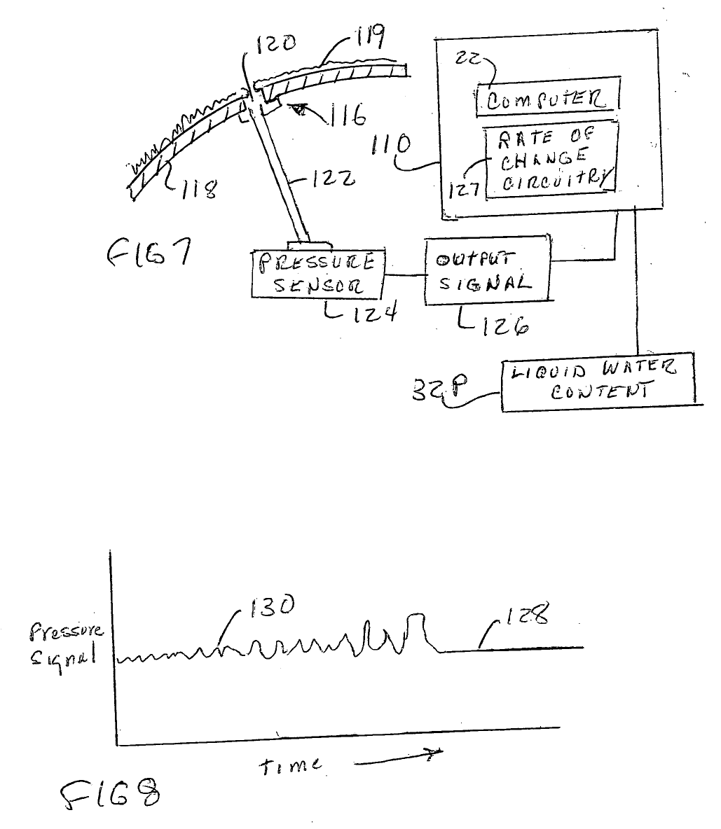

FIG. 9 shows a further modified ice detector 136, which in this case, is based upon a microwave wave guide system. A surface or wall 138 that can be part of a probe, or a surface of an aircraft or similar vehicle across which air flows, has a microwave wave guide 140 of suitable material deposited thereon.

The microwave wave guide 140 is excited with a frequency source 142, in this instance. The output of the frequency source 142 is connected with a line 144 to one end of the microwave wave guide 140, and the other end of the microwave wave guide 140 is connected with a line 146 to one input of a comparator 148. The output line 144 from the frequency source is also connected to the other input of the comparator along a line 150, and an output signal 160 is provided, which is a function of the differential between the signals on the lines 146 and 150.

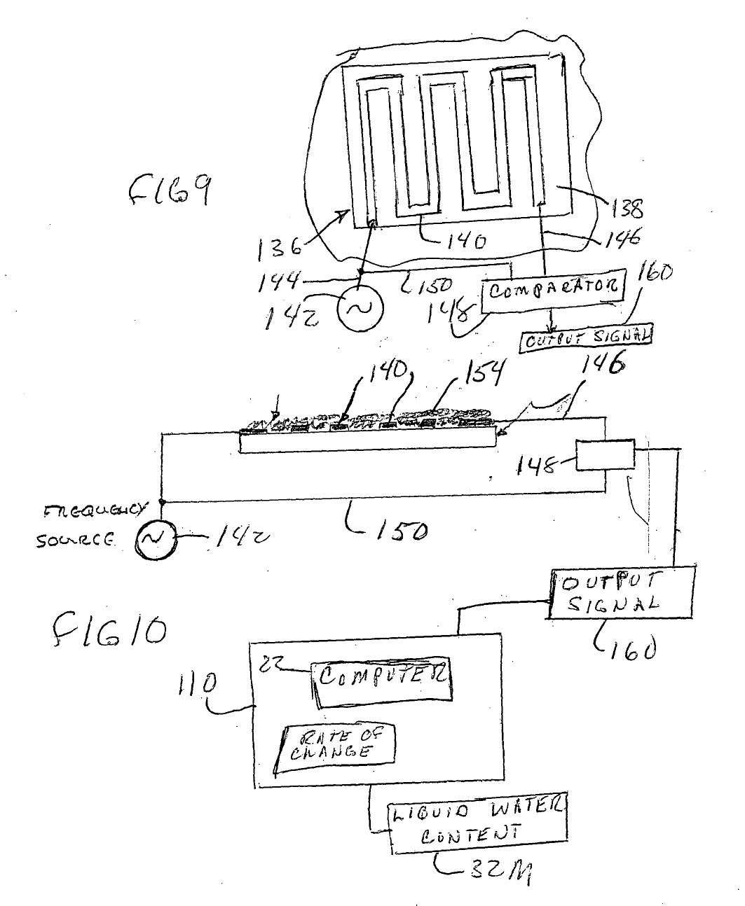

The frequency of the signal passed along microwave wave guide 140 is attenuated by the buildup of ice indicated at 154 (FIG. 10) over the microwave wave guide 140. The change in signal caused by the ice will be reflected in the output along line 146. When compared with the unattenuated input signal along line 150, output signal 160 from the comparator is a function of the ice accretion is provided. An output from the comparator function of the speed at which ice is accreted on the wave guide 140. This output signal 160 is then processed to provide the rate of change of ice accretion using the computation circuitry 110 which again would include the functions previously described, including a computer. The rate of change of ice accretion signal is combined with the pressure, temperature, and aircraft constants to provide a liquid water output signal 32M.

A thermally based ice detector is indicated in FIG. 11 at 161. It also should be noted that a thermal type ice detector is shown in U.S. Pat. No. 5,575,440. The ice detector 161 includes a thermometer body 162 that is provided with a self-heating resistance thermometer indicated at 164 in cross section. The resistance element is formed in any desired path on the surface of the body. The thermometer body 162 would be part of or embedded in a surface of a sensing probe or of an aircraft or the like.

The resistance thermometer 164 is powered through a power source 166, and the resistance of the thermometer is monitored with both a current meter 168 and a voltage meter 170, as the thermometer is heated. The power from power source 166 is cycled in repeating periods of time. In other words, the power would be shut off for a set period of time to let ice indicated at 172 accrete on the resistance thermometer 164, and then when power was turned back on, the time that was needed to melt the accreted ice, is determined.

The ice melt would be complete when the resistance of the self-heating thermometer started to increase. The voltage and current is monitored by a circuit in computation circuit 110. The time needed to melt the ice can be used to determine the rate of change of ice accretion. The time to melt the ice for a given set of parameters such as air temperature, air speed and air vehicle configuration is proportional to the amount of ice that had accreted. The rate of change of ice accretion is calculated. The computation circuitry 110 includes the previous inputs of temperature, constant, pressure and the appropriate look-up tables or algorithms, and provides an output indicating liquid water content at 32T in FIG. 11.

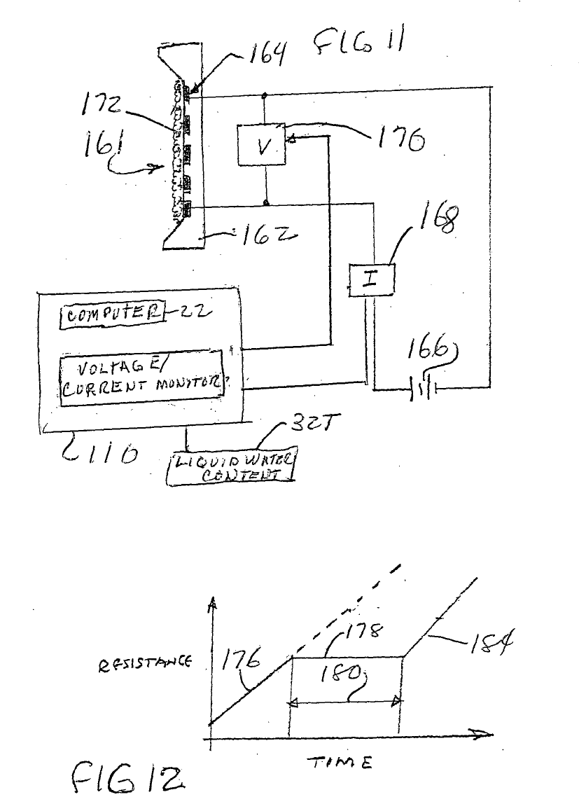

FIG. 12 illustrates the functions between the resistance of the self-heating resistance thermometer 164 relative to time, when it is powered. The resistance line indicated at 176 shows the change of resistance, or the increase in resistance during a set period of time, when no ice is present. The dotted continuation of line 176 is for reference, again showing the increase in resistance with no ice present. If ice is present, the resistance would plateau at the equivalent of 0° C. as indicated by the line 178, and the time indicated by line 180 before the resistance starts to increase again at point 182 indicates the rate of accretion. When used in a number of heating cycles, it provides a signal proportional to the rate of change of ice accretion. The increase in resistance indicated by line 184 is subsequent to removal of the accreted ice, and parallels line 176, showing resistance change with time when no ice is present.

Thus, the ice accretion rate can be determined, and will provide the liquid water content output on the basis of the calculations previously provided using the rate of change in frequency in the first form of the invention.

For all forms of the invention the rate change of the ice accretion is determined to provide an indication of liquid water content of the air causing the ice accretion.

The present invention thus uses readily available information for providing the liquid water content of airflow past a vibrating type probe such as an ice detector probe. The determination of the rate of change of frequency is a straight forward computation based upon the change in frequency across a time measurement. The discovery that the rate of change of frequency of a vibrating type ice detector probe provides reliable indications of liquid water content at substantially all useful ranges of such liquid water content in ambient air permits enhanced operation of air vehicles in particular, insofar as deicing equipment is concerned, and enhances the ability to make liquid water content measurements of reasonable quality for research purposes.

The indication of liquid water content is reliably obtained, even when the liquid water content is above the Ludlam Limit.

Although the present invention has been described with reference to preferred embodiments, workers skilled in the art will recognize that changes may be made in form and detail without departing from the spirit and scope of the invention.

What is claimed is:

1. An apparatus for determining liquid water content in a body of air, comprising a probe system comprising a probe configured to permit measuring a rate at which ice accretes on the probe from supercooled water in a body of air; a sensing circuit to sense a parameter that changes as ice accretes on the probe and to provide an output signal which is a function of ice accretion on the probe, means for providing signals indicative of air temperature and relative velocity of the body of air as air moves relative to the probe; a logic device communicatively connected to the probe system, configured to accept inputs from the sensing circuit, and inputs representing air temperature and relative velocity of the body of air from the means for providing, and a set of stored data providing an input to the logic device, the logic device performing operations on the inputs including determining the rate of change of ice accretion, and producing an output indicating liquid water content in the body of air using the set of stored data.

2. The apparatus of claim 1, and a heating device communicatively connected to the logic device, and configured for heating the probe sufficiently when activated by an output from the logic device, to diminish the ice accreted on the probe.

3. The apparatus of claim 1, wherein the logic device is configured to perform an operation on the inputs, including the stored data comprising calculating the liquid water content of the body of air when the liquid water content is above the Ludlam Limit.

4. The apparatus of claim 1, wherein the probe comprises a surface on which a ice accretes, and a sensor associated with said surface for determining when ice accretes thereon, to provide the output signal.

5. The apparatus of claim 1, wherein the probe comprises a surface on which ice accretes, a source of light directed toward said surface, a sensor for sensing light back scattered from accretion of ice on the surface, said sensor providing the output signal.

6. The apparatus of claim 1, wherein the probe comprises a surface having an orifice therein, a pressure sensor connected to the orifice, and the pressure sensor providing the output signal based on a function of ice blocking the orifice.

7. The apparatus of claim 6, wherein the output signal is based on measurement of time from when ice starts to block the orifice until the orifice is completely blocked.

8. The apparatus of claim 1, wherein said probe comprises a surface having a microwave wave guide thereon, a circuit connected to the microwave wave guide including a comparator for comparing signals directly from a source connected to the wave guide and from an output of the wave guide to determine changes when the source has ice accreting thereon, said comparator providing the output signal.

9. An apparatus for determining liquid water content in a body of air comprising a probe, a sensing device associated with the probe that provide a signal that changes predictably as a function of a quantity of ice accreted on the probe; the sensing device including a probe sensing circuit configured to provide a signal indicating the rate of ice accretion on the probe; a logic device, communicatively connected to the probe sensing circuit and configured to accept inputs comprising the signal indicating the rate of ice accretion, the temperature of the body of air and the relative airspeed past the probe, the logic device performing operations on the inputs and producing outputs based on the operations; a memory storage device, communicatively connected to the logic device, configured to supply stored data as an input to the logic device, including stored data representing measurements of liquid water content under known conditions of rate of change of the signal indicating the rate of ice accretion on the probe, the temperature of the body of air and the relative airspeed past the probe, and the logic device correlating the rate of change of the signal indicating the rate of ice accretion on the probe, the temperature of the body of air and the relative airspeed past the probe with the stored data to provide an output indicating liquid water content in the body of air.

10. The apparatus of claim 9, wherein the logic device is configured to perform at least one cycle of temporarily activating a heating device to heat the probe, determining the rate of change of ice accretion of the probe after the heating device has been deactivated, and then correlating the determined rate of change of ice accretion after heating with the other inputs.

11. The apparatus of claim 10, wherein the set of stored data comprises data from previous tests of the probe under controlled conditions, configured to serve as a basis for comparison with new inputs.

12. A method of determining liquid water content in an airflow, for signaling icing conditions for an aircraft, wherein the aircraft is moving relative to the air flow, including providing an ice detector probe on the aircraft, providing an ice detector sensor on the probe having an output that changes as ice accretes on the probe, determining changes in the output of the ice detector sensor to provide a rate signal indicating rate of ice accretion on the ice detector probe, determining the rate of change of the rate signal, determining airspeed of the air vehicle, determining air temperature of the airflow, and correlating the parameters comprising the rate signal, the determined airspeed and the determined airflow temperature with previously established relationships between these parameters stored in one of a lookup table and algorithm for providing an output indicating liquid water content of the air.

13. The method of claim 12 further comprising, performing at least one cycle of heating the probe to remove ice accreted thereon, and repeating the steps of determining the rate of change of the rate signal, the temperature, and the airspeed, and performing the correlating to provide a new output indicating liquid water content of the airflow.
